(19) United States
(12) Patent Application Publication
(10) Pub. No.: US 2016/0135083 A1
(43) Pub. Date: May 12, 2016

(54) METHOD AND APPARATUS FOR TRANSMITTING FRAMES

(71) Applicant: NEWRACOM, INC., Irvine, CA (US)

(72) Inventors: Ilgu LEE, Daejeon (KR); Jeongchul SHIN, Daejeon (KR); Kyeongpyo KIM, Daejeon (KR)

(21) Appl. No.: 14/935,375

(22) Filed: Nov. 6, 2015

Related U.S. Application Data
(60) Provisional application No. 62/077,073, filed on Nov. 7, 2014.

(30) Foreign Application Priority Data
Oct. 8, 2015 (KR) 10-2015-0141660

(51) Int. Cl. H04W 28/06

(52) U.S. Cl. CPC H04W 28/06; H04W 84/12

(57) ABSTRACT

A method for transmitting frames by a device in a wireless local area network is provided. The method includes transmitting a first frame including a recommended transmission rate and receiving a second frame transmitted as a response of the first frame, in which the second frame is transmitted at a rate determined based on the recommended transmission rate.

### CROSS-REFERENCE TO RELATED APPLICATION

This application claims priority to and the benefit of U.S. Patent Application No. 62/077,073 filed in the USPTO on Nov. 7, 2014, and Korean Patent Application No. 10-2015-0141660 filed in the Korean Intellectual Property Office on Oct. 8, 2015, the entire contents of which are incorporated herein by reference.

### BACKGROUND

(a) Field

The described technology relates to a method and an apparatus for transmitting frames, and more particularly, to a method and an apparatus for transmitting frames in a wireless local area network (hereinafter, referred to as WLAN).

(b) Description of the Related Art

A WLAN is being standardized by the IEEE (Institute of Electrical and Electronics Engineers) Part 11 under the name of “Wireless LAN Medium Access Control (MAC) and Physical Layer (PHY) Specifications”. The IEEE standard 802.11a (IEEE Std 802.11a-1999) supporting 2.4 GHz band was published in 1999 and the IEEE standard 802.11g (IEEE Std 802.11g-2003) supporting 5 GHz band was published in 2003. These standards are called legacy. Subsequently, the IEEE standard 802.11n (IEEE Std 802.11n-2009) for enhancements for higher throughput (HT) was published in 2009, and the IEEE standard 802.11ac (IEEE 802.11ac-2013) for enhancements for very high throughput (VHT) was published in 2013. Recently, a high efficiency WLAN (HEW) for enhancing the system throughput in high density scenarios is being developed by the IEEE 802.11ax task group.

The IEEE standard 802.11 defines a data transmission rate based on parameters such as a modulation and coding scheme (MCS). Further, the IEEE standard 802.11 defines a method for selecting a transmission rate of a control response frame. According to the IEEE standard 802.11, the transmission rate of the response frame is the highest rate selected among a basic transmission rate set of a basic service set (BSS) while being equal to or less than a transmission rate of a previous frame. The WLAN device may transmit the response frame at 24 Mbps which is the highest rate among a basic transmission rate set (6 Mbps, 12 Mbps, and 24 Mbps) of a BSS.

Meanwhile, the wireless communication environment may be various like an interference condition, a high quality link condition, or the like. For example, the WLAN device may transmit/receive the response frame in dense networks consisting of a plurality of BSSs. An unsymmetrical interference condition that interference through which data senders and data receivers go in the dense networks is unsymmetrical may occur frequently. When the data receiver which does not know the interference condition of the data sender transmits the response frame at the highest rate among the basic transmission rate set of the BSS, the response frame may be lost due to the interference of the data sender. In contrast, when the WLAN device performs communications under the high quality link condition, there is no problem to transmit the response frame at a higher rate than that defined in the IEEE 802.11 standard. However, even though the high quality link is guaranteed, the WLAN device just transmits the response frame at the highest rate among the fixed basic transmission rate set of the BSS.

Since the transmission rate of the response frame is fixed at the highest rate among the basic transmission rate set of the BSS, there is a limitation to increase system throughput.

The above information disclosed in this Background section is only for enhancement of understanding of the background of the invention and therefore it may contain information that does not form the prior art that is already known in this country to a person of ordinary skill in the art.

### SUMMARY

An embodiment of the present disclosure provides a method and an apparatus for transmitting frames to select a transmission rate of a response frame.

According to an embodiment, a method for transmitting frames by a device in a wireless local area network is provided. The method includes transmitting a first frame including a recommended transmission rate and receiving a second frame transmitted as a response of the first frame, in which the second frame is transmitted at a rate determined based on the recommended transmission rate.

The recommended transmission rate may be included in a transmission rate recommendation field and the transmission rate recommendation field may be included in a PHY header or a MAC header of the first frame.

The transmission rate recommendation field may be included in a signal field of the first frame.

The transmission rate recommendation field may include a value indicating a designated transmission rate or modulation and coding scheme (MCS) index.

A duration field of the first frame may include a duration value and the duration value may be determined based on a transmission time of the second frame transmitted at the recommended transmission rate.

A legacy signal (L-SIG) field of the first frame may include a data length and the data length may be determined based on the first frame and the transmission time of the second frame transmitted at the recommended transmission rate.

The method may further include: determining the recommended transmission rate based on an interference condition.

In the determining of the recommended transmission rate, when an interference level is equal to or more than a first reference value, the recommended transmission rate is determined as a lower rate than a basic rate or when the interference level is equal to or less than a second reference value, the recommended transmission rate is determined as a higher rate than the basic rate, the second reference value is a smaller than the first reference value, and the basic rate is the highest rate among a basic transmission rate set of a basic service set (BSS) while being equal to or less than a transmission rate of the first frame.

According to another embodiment, a method for transmitting frames by a device in a wireless local area network is provided. The method includes receiving a first frame including a recommended transmission rate and transmitting a second frame at a transmission rate determined based on the recommended transmission rate.

The recommended transmission rate may be included in the transmission rate recommendation field of the first frame and the transmission rate recommendation field may be included in a PHY header or a MAC header of the first frame.

The transmission rate recommendation field may be included in a signal field of the first frame.

The transmission rate recommendation field may include a value indicating a designated transmission rate or modulation and coding scheme (MCS) index.

The transmission rate of the second frame is determined as a same rate as the recommended transmission rate.

The transmission rate of the second frame is determined as a higher rate or lower rate than the recommended transmission rate.

According to yet another embodiment, a wireless local area network (WLAN) device includes a processor generating a first frame including a recommended transmission rate and a transceiver transmitting the first frame and receiving a second frame transmitted as a response of the first frame, in which the second frame is transmitted at a rate determined based on the recommended transmission rate.

The processor may insert the recommended transmission rate into a designated field of the first frame.

The processor may calculate a transmission time of the second frame transmitted at the recommended transmission rate and set a duration value of a duration field of the first frame based on the transmission time.

The processor may calculate the first frame and the transmission time of the second frame transmitted at the recommended transmission rate and set a data length of a legacy signal (L-SIG) field of the first frame based on the transmission time.

The processor may determine the recommended transmission rate based on an interference condition.

The processor may determine a lower rate than a basic rate as the recommended transmission rate when an interference level is equal to or more than a first reference value or determine a higher rate than the basic rate as the recommended transmission rate when the interference level is equal to or less than a second reference value, the second reference value may be a value smaller than the first reference value, and the basic rate may be the highest rate among a basic transmission rate set of a basic service set (BSS) while being equal to or less than a transmission rate of the first frame.

According to present disclosure, it is possible to control the transmission rate of the response frame based on the interference information. By doing so, it is possible to improve the transmission success of the response frame by adjusting the transmission rate of the response frame when the interference is present and improve the transmission efficiency by adjusting the transmission rate of the response frame when the high quality link is guaranteed. According to an exemplary embodiment, it is possible to improve the aggregate throughput and the power efficiency.

### BRIEF DESCRIPTION OF THE DRAWINGS

FIG. 1 is a schematic block diagram of a WLAN device according to an embodiment.

FIG. 2 is a schematic block diagram of a transmitting signal processor in an embodiment suitable for use in a WLAN.

FIG. 3 is a schematic block diagram of a receiving signal processing unit in an embodiment suitable for use in the WLAN.

FIG. 4 exemplifies illustrates Inter-Frame Space (IFS) relationships.

FIG. 5 is a schematic diagram illustrating a CSMA/CA based frame transmission procedure for avoiding collision between frames in a channel.

FIG. 6 shows an example of an unsymmetrical interference condition of a wireless communication network.

FIG. 7 schematically shows an ACK frame loss under the unsymmetrical interference condition.

FIG. 8 schematically shows a response frame loss under the unsymmetrical interference condition.

FIG. 9 shows an example of a high quality link condition of the wireless communication network.

FIG. 10 is a flow chart of a method for selecting a transmission rate of a response frame according to an embodiment.

FIG. 11 shows a frame format of the wireless communication network including a transmission rate recommendation field according to an embodiment.

FIG. 12, FIG. 13 and FIG. 14 each schematically show frame transmissions of the method for selecting a transmission rate of a response frame according to an embodiment.

FIG. 15, FIG. 16, FIG. 17 and FIG. 18 each schematically show frame transmissions of a method for selecting a transmission rate of a response frame according to another embodiment.

FIG. 19 schematically shows frame transmissions in the wireless communication network according to an embodiment.

FIG. 20 schematically shows an inter-frame space by the selection of the transmission rate of the response frame according to an embodiment.

### DETAILED DESCRIPTION OF THE EMBODIMENTS

In the following detailed description, only certain exemplary embodiments have been shown and described, simply by way of illustration. As those skilled in the art would realize, the described embodiments may be modified in various different ways, all without departing from the spirit or scope. Accordingly, the drawings and description are to be regarded as illustrative in nature and not restrictive. Like reference numerals designate like elements throughout the specification.

In a WLAN, a basic service set (BSS) includes a plurality of WLAN devices. The WLAN device may include a medium access control (MAC) layer, a physical (PHY) layer, or the like according to the IEEE (Institute of Electrical and Electronics Engineers) standard 802.11. The plurality of WLAN devices may include at least one WLAN device that is an access point (AP) and the other WLAN devices that are non-AP stations (non-AP STAs). Alternatively, all of the plurality of WLAN devices may be non-AP STAs in ad-hoc networking. In general, the AP STA and the non-AP STA may be collectively called the STAs. However, for ease of description, herein, only the non-AP STAs are referred to as the STAs.

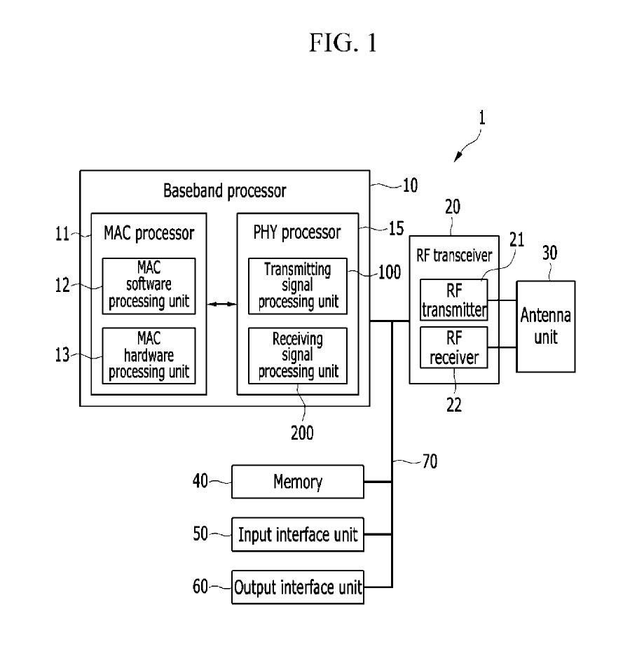

FIG. 1 is a schematic block diagram exemplifying a structure of a WLAN.

Referring to FIG. 1, the WLAN device 1 includes a baseband processor 10, a radio frequency (RF) transceiver 20, an antenna unit 30, a memory 40, an input interface unit 50, an output interface unit 60, and a bus 70.

The baseband processor 10 performs baseband related signal processing described in the present specification, and includes a MAC processor 11 and a PHY processor 15.

In one exemplary embodiment, the MAC processor 11 may include a MAC software processing unit 12 and a MAC hardware processing unit 13. The memory 40 may store software (hereinafter referred to as “MAC software”) including at least some functions of the MAC layer. The MAC software processing unit 12 executes the MAC software to implement the some functions of the MAC layer, and the MAC hardware processing unit 13 may implement remaining functions of the MAC layer as hardware (hereinafter referred to “MAC hardware”). However, the MAC processor 11 is not limited to this.

The PHY processor 15 includes a transmitting (Tx) signal processing unit 100 and a receiving (Rx) signal processing unit 200.

The baseband processor 10, the memory 40, the input interface unit 50, and the output interface unit 60 may communicate with each other via the bus 70.

The RF transceiver 20 includes an RF transmitter 21 and an RF receiver 22.

The memory 40 may further store an operating system and applications in addition to MAC software. The input interface unit 50 receives information from a user, and the output interface unit 60 outputs information to the user.

The antenna unit 30 includes one or more antennas. When multiple-input multiple-output (MIMO) or multi-user MIMO (MU-MIMO) is used, the antenna unit 30 may include a plurality of antennas.

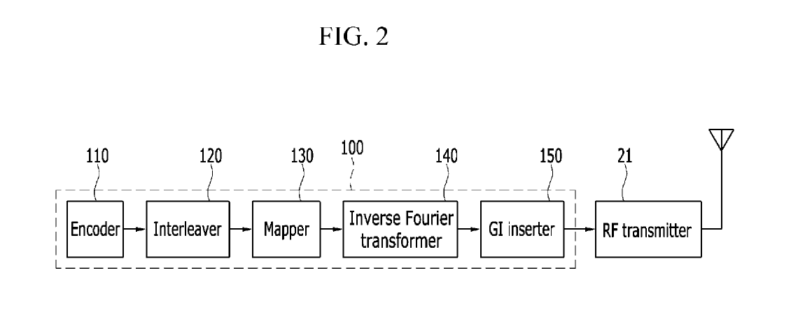

FIG. 2 is a schematic block diagram exemplifying a transmitting signal processing unit in the WLAN.

Referring to FIG. 2, a transmitting signal processing unit 100 includes an encoder 110, an interleaver 120, a mapper 130, an inverse Fourier transformer (IFT) 140, and a guard interval (GI) inserter 150.

The encoder 110 encodes input data. For example, the encoder 110 may be a forward error correction (FEC) encoder. The FEC encoder may include a binary convolutional code (BCC) encoder followed by a puncturing device. Alternatively, the FEC encoder may include a low-density parity-check (LDPC) encoder.

The transmitting signal processing unit 100 may further include a scrambler for scrambling the input data before the encoding to reduce the probability of long same sequences of 0s or 1s. When a plurality of BCC encoders are used as the encoder 110, the transmitting signal processing unit 100 may further include an encoder parser for demultiplexing the scrambled bits with a plurality of BCC encoders. When the LDPC encoder is used as the encoder 110, the transmitting signal processing unit 100 may not use the encoder parser.

The interleaver 120 interleaves the bits of each stream output from the encoder 110 to change an order of bits. Interleaving may be applied only when BCC encoder is used as the encoder 110. The mapper 130 maps the sequence of bits output from the interleaver 120 to constellation points. When the LDPC encoder is used as the encoder 110, the mapper 130 may further perform LDPC tone mapping besides the constellation point mapping.

When the MIMO or the MU-MIMO is used, the transmitting signal processing unit 100 may use a plurality of interleavers 120 and a plurality of mappers 130 corresponding to a number of spatial streams NSS. In this case, the transmitting signal processing unit 100 may further include a stream parser for dividing outputs of a plurality of BCC encoders or LDPC encoders into a plurality of blocks that are sent to different interleavers 120 or mappers 130. The transmitting signal processing unit 100 may further include a space-time block code (STBC) encoder for spreading the constellation points from the NSS spatial streams into NSTS space-time streams and a spatial mapper for mapping the space-time streams to transmit chains. The spatial mapper may use direct mapping, spatial expansion, or beamforming.

The IFT 140 converts a block of the constellation points output from the mapper 130 or the spatial mapper to a time domain block (i.e., a symbol) by using an inverse discrete Fourier transform (IDFT) or an inverse fast Fourier transform (IFFT). If the STBC encoder and the spatial mapper are used, the inverse Fourier transformer 140 may be provided for each transmit chain.

When the MIMO or the MU-MIMO is used, the transmitting signal processing unit 100 may insert cyclic shift diversities (CSDs) to prevent unintentional beamforming. The CSD insertion may occur before or after the inverse Fourier transform. The CSD may be specified per transmit chain or may be specified per space-time stream. Alternatively, the CSD may be applied as a part of the spatial mapper.

When the MU-MIMO is used, some blocks before the spatial mapper may be provided for each user.

The GI inserter 150 prepends a guard interval (GI) to the symbol. The transmitting signal processing unit 100 may optionally perform windowing to smooth edges of each symbol after inserting the GI. The RF transmitter 21 converts the symbols into an RF signal and transmits the RF signal via the antenna unit 30. When the MIMO or the MU-MIMO is used, the GI inserter 150 and the RF transmitter 21 may be provided for each transmit chain.

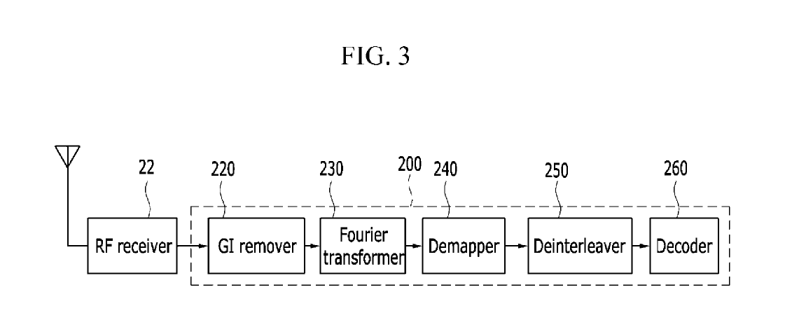

FIG. 3 is a schematic block diagram of a receiving signal processing unit suitable for use in the WLAN.

Referring to FIG. 3, a receiving signal processing unit 200 includes a GI remover 220, a Fourier transformer (FT) 230, a demapper 240, a deinterleaver 250, and a decoder 260.

An RF receiver 22 receives an RF signal via the antenna unit 30 and converts the RF signal into a symbol. The GI remover 220 removes the GI from the symbol. When the MIMO or the MU-MIMO is used, the RF receiver 22 and the GI remover 220 may be provided for each receive chain.

The FT 230 converts the symbol (i.e., the time domain block) into a block of the constellation points of a frequency domain by using a discrete Fourier transform (DFT) or a fast Fourier transform (FFT). The Fourier transformer 230 may be provided for each receive chain.

When the MIMO or the MU-MIMO is used, the receiving signal processing unit 200 may include a spatial demapper for converting the Fourier transformed receive chains to constellation points of the space-time streams, and an STBC decoder for despreading the constellation points from the space-time streams into the spatial streams.

The demapper 240 demaps the constellation point blocks output from the Fourier transformer 230 or the STBC decoder to the bit streams. If the received signal is LDPC-encoded is used, the demapper 240 may further perform LDPC tone demapping before the constellation point demapping. The deinterleaver 250 deinterleaves the bits of each stream output from the demapper 240. Deinterleaving may be applied only when the received signal is BCC-encoded.

When the MIMO or the MU-MIMO is used, the receiving signal processing unit 200 may use a plurality of demappers 240 and a plurality of deinterleavers 250 corresponding to the number of spatial streams. In this case, the receiving signal processing unit 200 may further include a stream deparser for combining the streams output from the plurality of deinterleavers 250.

The decoder 260 decodes the streams output from the deinterleaver 250 or the stream deparser. For example, the decoder 260 may be an FEC decoder. The FEC decoder may include a BCC decoder or an LDPC decoder. The receiving signal processing unit 200 may further include a descrambler for descrambling the data decoded in the decoder 260. When a plurality of BCC decoders are used as the decoder 260, the receiving signal processing unit 200 may further include an encoder deparser for multiplexing the data decoded by a plurality of BCC decoders. When the LDPC decoder is used as the decoder 260, the receiving signal processing unit 200 may not use the encoder deparser.

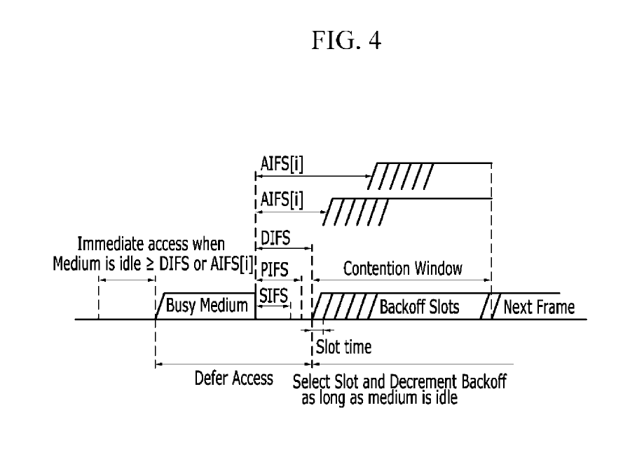

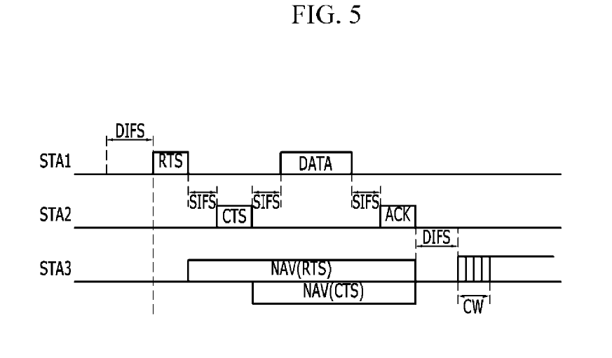

FIG. 4 is a diagram illustrating interframe space (IFS) relationships.

A data frame, a control frame, and a management frame may be exchanged between the WLAN devices.

The data frame is used for transmission of data forwarded to a higher layer. The WLAN device transmits the data frame after performing backoff if a distributed coordination function IFS (DIFS) has elapsed from a time when the medium has been idle. The management frame is used for exchanging management information which is not forwarded to the higher layer and is transmitted after performing backoff when IFS such as the DIFS or a point coordination function (PIFS) has elapsed. Subtype frames of the management frame include a beacon frame, an association request/response frame, a probe request/response frame, and an authentication request/response frame. The control frame is used for controlling access to the medium. Subtype frames of the control frame include a request to send (RTS) frame, a clear to send (CTS) frame, and an acknowledgement (ACK) frame. When the control frame is not a response frame of the other frame, the WLAN device transmits the control frame after performing backoff when the DIFS has elapsed. When the control frame is the response frame of the other frame, the WLAN device transmits the control frame without performing backoff when a short IFS (SIFS) has elapsed. The type and subtype of a frame may be identified by a type field and a subtype field in a frame control field.

On the other hand, a Quality of Service (QoS) STA may transmit the frame after performing backoff when an arbitration IFS (AIFS) for access category (AC) to which the frame belongs, i.e., AIFS[AC], has elapsed. In this case, the data frame, the management frame, or the control frame which is not the response frame may use the AIFS[AC].

FIG. 5 is a schematic diagram illustrating a CSMA (carrier sense multiple access)/CA (collision avoidance) scheme based on frame transmission procedure for avoiding collision between frames in a channel.

Referring to FIG. 5, a first device STA1 is a transmit WLAN device for transmitting data and a second device STA2 is a receive WLAN device for receiving the data transmitted from the first device STA1. A third device STA3 is a third WLAN device which may be located at an area where a frame transmitted from the STA1 and/or a frame transmitted from the STA2 can be received.

The STA1 may determine whether the channel is busy by carrier sensing. The STA1 may determine the channel occupation based on an energy level on the channel or correlation of signals in the channel, or may determine the channel occupation by using a network allocation vector (NAV) timer.

When it is determined that the channel is not in use by other devices during DIFS (that is, that the channel is idle), the STA1 may transmit an RTS frame to the STA2 after performing backoff. Upon receiving the RTS frame, the STA2 may transmit a CTS frame as a response of the RTS frame after a SIFS to the STA1.

When the STA3 receives the RTS frame, it may set the NAV timer for a transmission duration of subsequently continuously transmitted frames (for example, a duration of SIFS+CTS frame duration+SIFS+data frame duration+SIFS+ACK frame duration) by using duration information included in the RTS frame. When the STA3 receives the CTS frame, it may set the NAV timer for a transmission duration of subsequently continuously transmitted frames (for example, a duration of SIFS+data frame duration+SIFS+ACK frame duration) by using duration information included in the CTS frame. Upon receiving a new frame before the NAV timer expires, the STA3 may update the NAV timer by using duration information included in the new frame. The STA3 does not attempt to access the channel until the NAV timer expires.

When the STA1 receives the CTS frame from the STA2, it may transmit a data frame to the STA2 after SIFS elapses from a time when the CTS frame has been completely received. Upon successfully receiving the data frame, the STA2 may transmit an ACK frame as a response of the data frame after a SIFS elapses to the STA1.

When the NAV timer expires, the STA3 may determine whether the channel is busy by the carrier sensing. Upon determining that the channel is not in use by the other devices during DIFS after the NAV timer has expired, the STA3 may attempt the channel access after a contention window (CW) according to random backoff elapses.

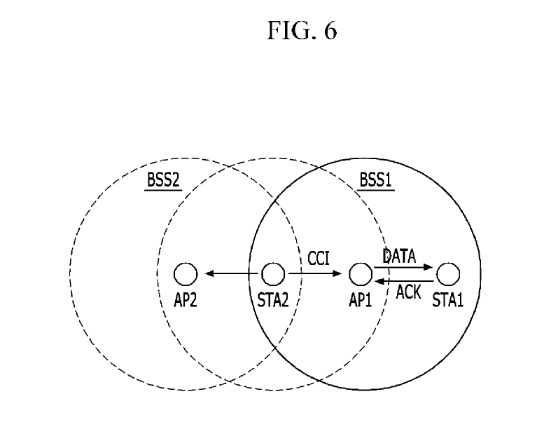

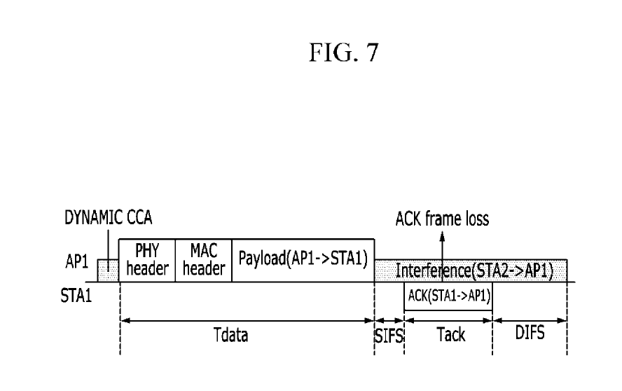

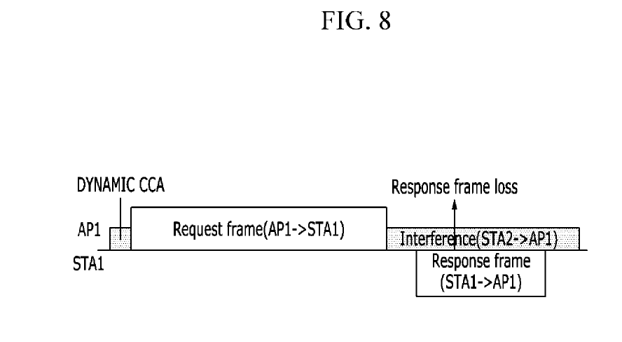

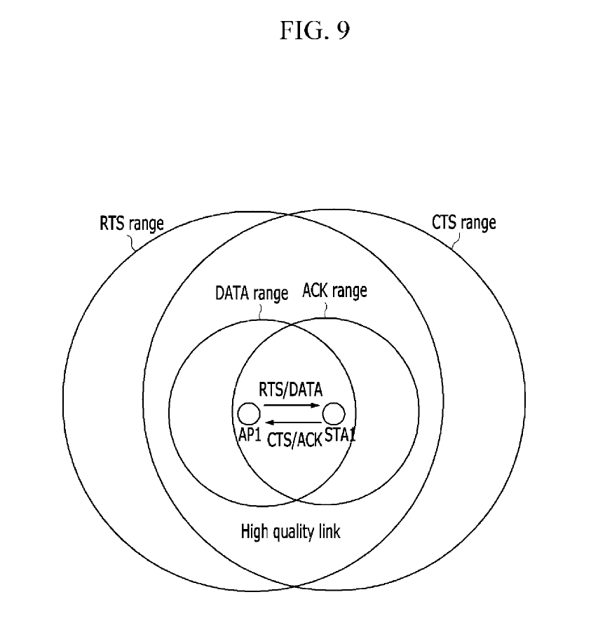

FIG. 6 shows an example of an unsymmetrical interference condition of a wireless communication network, FIG. 7 schematically shows an ACK frame loss under the unsymmetrical interference condition, FIG. 8 schematically shows a response frame loss under the unsymmetrical interference condition, and FIG. 9 shows an example of a high quality link condition of the wireless communication network.

The unsymmetrical interference condition will be exemplarily described with reference to FIG. 6. The unsymmetrical interference condition means that the interference that the transmit device and the receive device go through is different. For example, the transmit device goes through the interference by a hidden node but the receive device may not go through the interference and does not have any information about the interference. The receive device goes through the interference by the hidden node but the transmit device may not go through the interference and does not have any information about the interference.

The wireless communication network may consist of the plurality of overlapping BSSs. For example, a WLAN communication network includes an AP1, an AP2, a STA1, and a STA2. It is assumed that the AP1 and the STA1 may be included in a BSS1, the AP2 and the STA2 may be included in a BSS2, and the STA2 may also access the AP1. Here, the AP1 is a data sender and the STA1 is a data receiver. The STA2 is an overlapping BSS (OBSS) node and is an interferer of the AP1.

Referring to FIGS. 6 and 7, the AP1 may transmit data to the STA1 through a dynamic sensitivity control (DSC) even though there is co-channel interference (CCI) of the STA2 included in other BSSs. The AP1 may dynamically adjust a clear channel assessment (CCA) level through the dynamic sensitivity control.

The STA1 transmits an ACK frame as a response to data frame to the AP1. According to the IEEE standard 802.11, the transmission rate of the ACK frame is the highest rate (that is, 24 Mbps) selected among a basic transmission rate set of the BSS while being equal to or less than the transmission rate of the data frame.

However, the AP1 is affected by the interference from the STA2. Therefore, if the STA1 transmits the ACK frame at the highest rate among the basic transmission rate set of the BSS, the ACK frame loss may be occurred due to the interference.

Referring to FIGS. 6 and 8, the AP1 performs a dynamic CCA check and even though there is the interference of the STA2, may transmit a request frame to the STA1.

The STA1 transmits a response frame for the request frame. According to the IEEE standard 802.11, the transmission rate of the response frame is equal to or less than the transmission rate of the request frame but is the highest rate (that is, 24 Mbps) selected from a basic transmission rate set of the BSS.

However, the AP1 is affected by the interference from the STA2. Therefore, if the STA1 transmits the response frame at the highest rate among the basic transmission rate set of the BSS, the response frame loss may be occurred due to the interference.

As such, if the WLAN device is not aware of the interference condition of the other party and transmits the frame under the unsymmetrical interference condition, the frame collision may occur frequently. In particular, if the frame is transmitted at the high speed through the dynamic sensitivity control even though the transmit device is in the interference condition, the receive device is not aware of the interference condition of the transmit device and transmits the response frame at a rate (for example, 24 Mbps modulated by 16 QAM) according to a selection rule defined in the IEEE standard 802.11. In this case, compared to the response frame BPSK-modulated and transmitted at a robust rate (for example, 6 Mbps) against the interference, the possibility of the response frame loss may be increased.

Referring to FIG. 9, the AP1 transmits RTS (request to send) frame/data frame to the STA1.

The STA1 transmits CTS (clear to send) frame/ACK frame to the AP1. The STA1 selects the highest rate among the basic transmission rate set of the BSS while being equal to or less than the transmission rate of the receive frame to transmit the response frame.

In this case, the high quality link may be guaranteed between the AP1 and the STA1. For example, the high quality link may be guaranteed by a method for increasing transmit power of an RTS/CTS frame to widen an RTS/CTS range, a method for reducing transmit power of a data frame/ACK frame, and a quality measurement mechanism/protocol.

Even though the STA1 transmits the response frame at a higher rate than the upper limit rate of the basic transmission rate set of the BSS under the high quality link condition, the AP1 may receive the response frame. However, the previous WLAN device which does not support the present disclosure may not transmit the response frame at a higher rate than 24 Mbps even under the high quality link condition.

In addition, the WLAN device is hard to be aware of the interference condition of the other party in dense networks in which the unsymmetrical interference condition may be present. Therefore, the WLAN device which does not know the interference condition of the other party is hard to select the appropriate transmission rate of the response frame.

Further, the WLAN device selects the transmission rate of the data frame and the transmission rate (24 Mbps) of the response frame according to the defined selection rule and calculates a duration of the channel occupation based on the transmission rate. Since neighbor devices set the NAV based on the duration information of the receive frame, the device that transmits the response frame may not arbitrarily select the transmission rate of the response frame affecting the NAV.

A method for selecting a transmission rate of a response frame according to an exemplary embodiment to solve these problems will be described in detail. The response frame means a frame transmitted to the response for the receive frame. For example, the response frame includes an ACK frame, a block ACK frame, a CTS frame, and various response frames to the request frames.

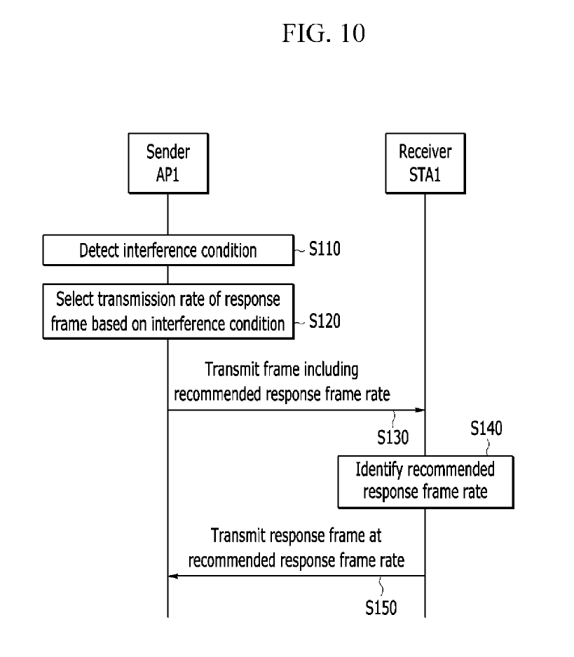

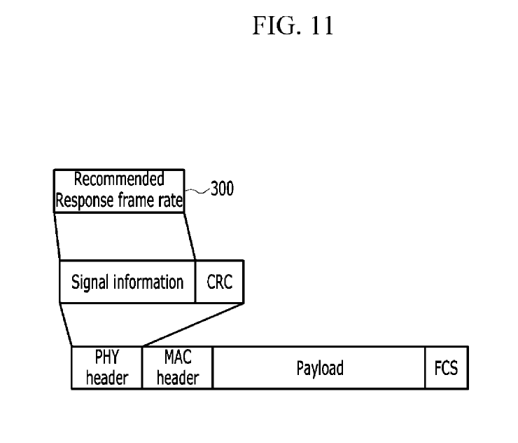

FIG. 10 is a flow chart of a method for selecting a transmission rate of a response frame according to an embodiment and FIG. 11 shows a frame format of the wireless communication network including a transmission rate recommendation field according to an embodiment.

Referring to FIG. 10, the sender AP1 determines the interference condition based on the channel condition (S110). The WLAN device may measure its own interference condition to obtain more transmission opportunities and may optimize the receiver sensitivity to improve throughput. The WLAN device may know its own channel condition by measuring and signal processing method and know corresponding node's channel condition by utilizing request/response frames.

The sender selects the transmission rate of the response frame based on the interference condition (S 120). The sender selects a rate at which the response frame may be successfully received based on the interference condition. A reference for selecting the rate may be defined variously. For example, when there is interference over a first reference value, the sender selects a lower rate than 24 Mbps. For example, when there is interference below a second reference value in the good channel condition, the sender selects a higher rate than 24 Mbps. For convenience, the rate selected for the receiver by the sender is called as a recommended response frame rate.

The sender transmits a frame including the recommended response frame rate (S130). The recommended response frame rate may be included in a PHY header or a MAC header of a transmit frame. Here, the transmit frame may be a PHY frame of the IEEE 802.11ax. Referring to FIG. 11, the recommended response frame rate is included in a transmission rate recommendation field 300. The transmission rate recommendation field 300 may be included in, for example, a signal filed of the PHY header including signal information.

The receiver identifies the recommended response frame rate included in the receive frame (S140).

The receiver transmits the response frame at the recommended response frame rate (S150).

The transmission rate recommendation field may be defined according to a response frame type.

The transmission rate recommendation field indicates the transmission rate of the ACK frame. For example, an ACK frame transmission rate recommendation field may be defined as in the following Table 1. The ACK frame transmission rate recommendation field may be 2 bits. If the transmission rate recommendation field is “0 (00)”, it may mean the highest rate among the basic transmission rate set of the BSS while being equal to or less than the transmission rate of the receive frame (or reference rate). If the transmission rate recommendation field is “1 (01)”, it may mean 6 Mbps, if the transmission rate recommendation field is “2 (10)”, it may mean 12 Mbps, and if the transmission rate recommendation field is “3 (11)”, it may mean 24 Mbps.

TABLE 1

| Transmission rate | |
|---|---|
| recommendation field | Meaning |
| 0 (00) | Highest rate among the basic transmission rate set |
| | of the BSS while being equal to or less than the |
| | transmission rate (or reference rate) of the receive |
| | frame |
| 1 (01) | 6 Mbps |
| 2 (10) | 12 Mbps |
| 3 (11) | 24 Mbps |

The response frame transmission rate recommendation field indicates a transmit mode of the response frame. For example, the response frame transmission rate recommendation field may be defined as in the following Table 2. The response frame transmission rate recommendation field may indicate MCS (Modulation and Coding Scheme) indexes (MCS1, MCS2, . . . , MCSN). The response frame transmission rate recommendation field consists of bits representing the supported MCS indexes. For example, if the transmission rate of MCS9 (N=9) is supported, the response frame transmission rate recommendation field requires 4 bits.

TABLE 2

| Transmission rate | |
|---|---|
| recommendation field | Meaning |
| 0 | Highest rate among the basic transmission rate |
| | set of the BSS while being equal to or least than |
| | the transmission rate (or reference rate) of the |
| | receive frame |
| 1 | MCS1 |
| 2 | MCS2 |
| . . . | |
| N | MCSN |

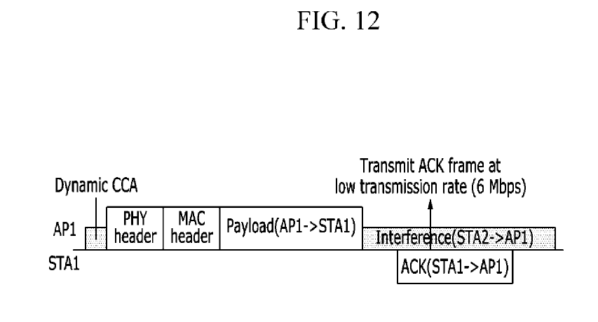

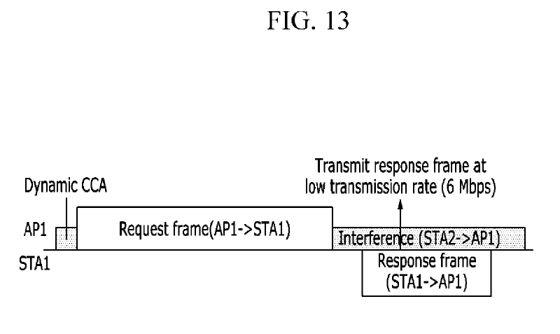

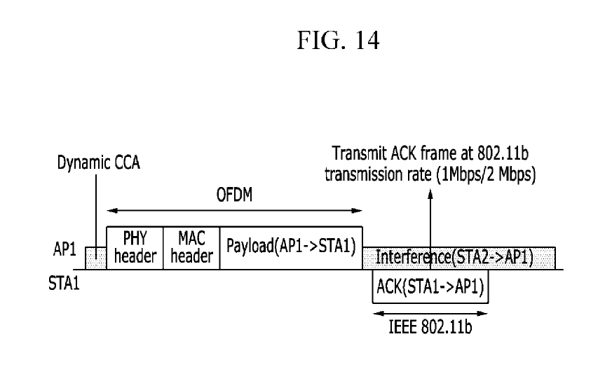

FIGS. 12 to 14 each schematically show frame transmissions of the method for selecting a transmission rate of a response frame according to an embodiment.

Referring to FIGS. 6, 12, and 13, the AP1 determines the recommended response frame rate based on the interference information. The AP1 is aware of its own interference and when the response frame loss is expected due to the interference, recommends the transmission rate of the response frame robust against the interference.

For example, when the AP1 transmits data to MCS9 through an 80 MHz channel, the data transmission rate defined in the IEEE 802.11ac is 390 Mbps. Referring to FIG. 12, the AP1 determines the transmission rate (for example, 6 Mbps) lower than 24 Mbps as the ACK frame recommendation rate, instead of 24 Mbps which is the highest rate among the basic transmission rate set of the BSS when the ACK frame loss is expected due to the interference of the STA2.

The STA1 identifies the recommendation rate included in the data frame and transmits the ACK frame at the recommended rate. The ACK frame may be successfully transmitted.

Referring to FIG. 13, the AP1 determines the transmission rate (for example, 6 Mbps) robust to the interference as the recommended response frame rate when the response frame loss is expected due to the interference by the STA2.

The STA1 identifies the recommendation rate included in the request frame and transmits the response frame at the recommended rate. The response frame may be successfully transmitted.

Referring to FIG. 14, the recommended response frame rate may be changed according to the IEEE standard 802.11 that is supported by the WLAN device. For example, when the AP1 and the STA1 support the IEEE standard 802.11b, the STA1 may transmit frames defined in the IEEE standard 802.11b. Therefore, the AP1 may determine the recommended response frame rate as a rate lower than the 6 Mbps, such as 1 Mbps or 2 Mbps, depending on the interference condition.

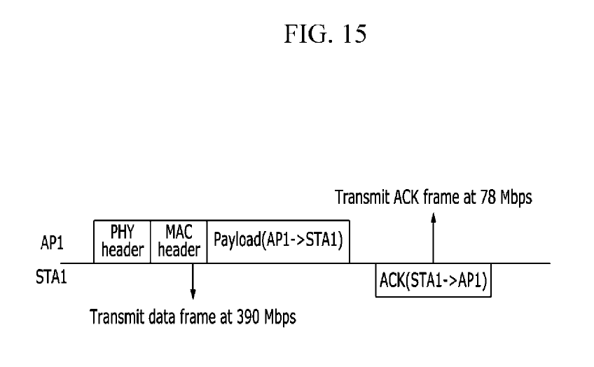

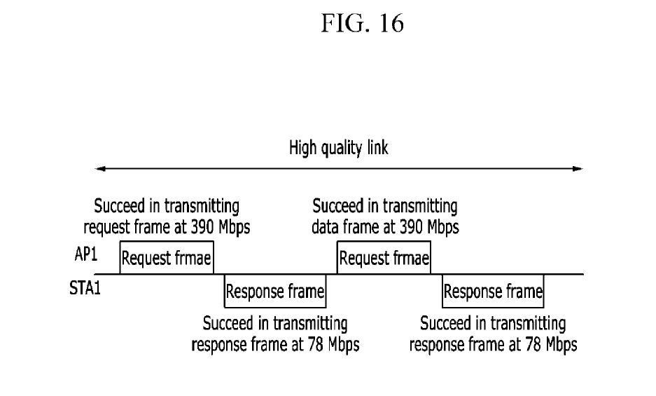

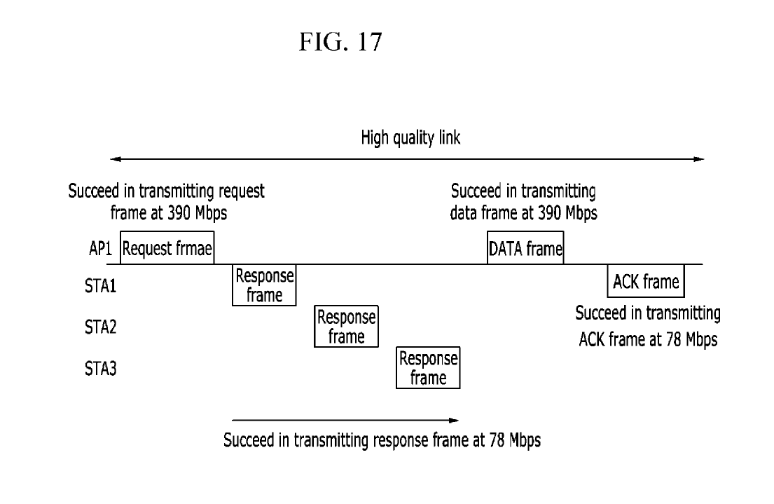

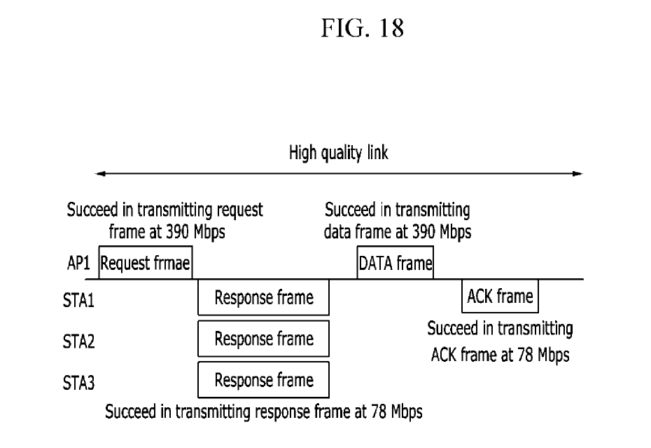

FIGS. 15 to 18 each schematically show frame transmissions of a method for selecting a transmission rate of a response frame according to another embodiment.

Referring to FIGS. 9 and 15, when the AP1 and the STA1 are in the high quality link, the AP1 may select the response frame transmission rate among rates below the transmit frame. For example, when the data transmission rate is 390 Mbps, the AP1 may select the recommended response frame rate as 78 Mbps. The STA1 identifies the recommendation rate included in the receive frame and transmits the response frame at the recommended rate.

Referring to FIGS. 16 to 18, the AP1 may transmit the request frame at, for example, 390 Mbps in the high quality link. The request frame may include the recommended response frame rate (for example, 78 Mbps).

The STA1 transmits the response frame at the recommendation rate included in the request frame. Under the high quality link, the response frame is successfully transmitted despite the high transmission rate. When the plurality of WLAN devices STA1, STA2, and STA3 receives the request frame, the plurality of WLAN devices STA1, STA2, and STA3 each may sequentially or simultaneously transmit the response frame at the recommended rate included in the request frame.

The AP1 may transmit the data frame to the STA1 and the data frame may include the ACK frame recommendation rate, for example, 78 Mbps.

The STA1 transmits the ACK frame as the ACK frame recommendation rate.

Next, the wireless communication network according to an embodiment may be a high efficiency (HE) WLAN developed by the IEEE 802.11ax task group. It is described that an HEW device supporting the HE WLAN recommends a response frame rate and protects the response frame transmitted at a recommended rate.

In particular, in the wireless communication network in which the HEW device and the legacy device are coexist, the method for protecting a response frame transmitted at the recommended rate will be described.

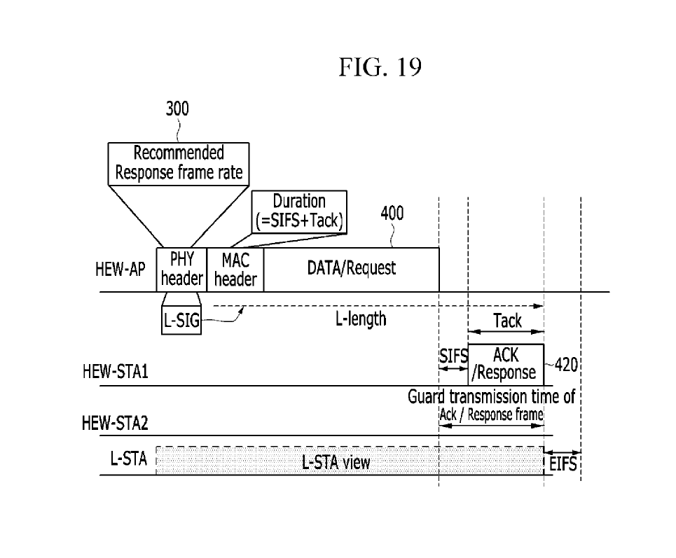

FIG. 19 schematically shows frame transmissions in the wireless communication network according to an embodiment.

Referring to FIG. 19, HEW devices HEW-AP, HEW-STA1, and HEW-STA2 and a legacy device L-STA are in the wireless communication network.

The sender HEW-AP transmits a frame 400 to a receiver HEW-STA1. The frame 400 is a PHY frame and may be, for example, a physical layer convergence procedure (PLCP) frame. The frame 400 includes a PHY header, a MAC header, and a frame body. The frame body includes a payload depending on a frame type and it is assumed that the frame type is the data frame or the request frame.

The sender HEW-AP recommends the transmission rate of the response frame based on the interference information and indicates the recommended response frame rate in the transmission rate recommendation field 300 of the PHY header or the MAC header. The transmission rate recommendation field may be included in the signal field exchanging signaling information as illustrated in FIG. 19. The transmission rate recommendation field includes response frame mode/rate indication.

The sender HEW-AP uses the recommended response frame rate to set a duration of a duration field of the MAC header. The duration includes an SIFS and a response frame transmission time Tack. In this case, the response frame transmission time Tack may be changed depending on the recommended response frame rate.

The HEW-STA1 and the HEW-STA2 identify an identifier included in a PHY signal field. The identifier includes ID information of a partial association ID (PAID), a BSS color, or the like.

The HEW-STA1 which is the receiver of the frame 400 decodes the frame body since the identifier of the frame 400 is same with an identifier of the HEW-STA1. When the decoding succeeds, the HEW-STA1 transmits a response frame 420 at the recommended response frame rate after the SIFS elapses.

Since the identifier of the receive frame is not same with an identifier of the HEW-STA2, the HEW-STA2 no longer processes the decoding of the MAC level. The HEW-STA2 may not operate the NAV protection by the duration field of the MAC header. Instead, the HEW-STA2 may know the transmission mode or transmission rate of the response frame 420 based on the transmission rate recommendation field included in the PHY signal field of the frame 400. The HEW-STA2 may calculate the transmission time of the response frame 420 based on the transmission mode or transmission rate of the response frame 420 and defer a medium access until the transmission time of the response frame 420.

As such, the HEW device may know that the transmission rate of the response frame is recommended based on the response frame mode/rate indication and protect the transmission duration up to the response frame 420 based on the transmission rate.

Meanwhile, the L-STA may not be aware of the transmission rate recommendation field defined for the HEW device. Therefore, the HEW-AP sets a length L-length of a legacy signal (L-SIG) field of the frame 400, including the response frame. By doing so, the L-STA may be aware of the response frame as the data length based on the length of the L-SIG field to protect the L-SIG. The L-STA defers the medium access during EIFS or EIFS−DIFS+AIFS [AC] after the response frame transmission is completed. Therefore, even though the HEW device selects the response frame transmission rate, the collision due the L-STA does not occur.

An L-SIG field includes a data transmission rate L-rate and a length L-length. The expanded length L-length may be calculated by multiplying the data transmission rate L-rate by the expanded transmission duration. The expanded transmission duration includes the transmission duration of the frame 400 and the transmission duration Tack of the response frame transmitted at the SIFS and the recommended rate.

As such, the HEW device may expand the length of the L-SIG field to the response frame to protect the transmission duration of the response frame 420.

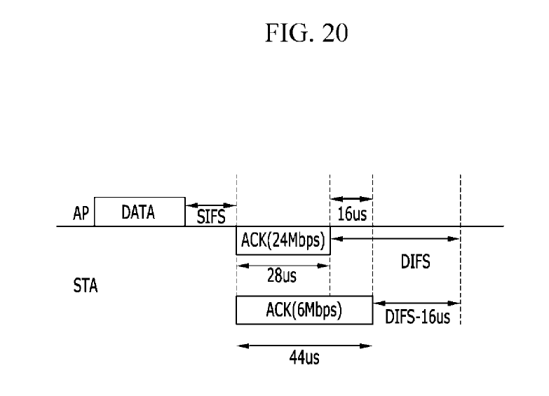

FIG. 20 schematically shows an inter-frame space by the selection of the transmission rate of the response frame according to an embodiment.

Referring to FIGS. 5 and 20, the receiver STA receives the data frame transmitted from the sender AP and transmits the ACK frame after the SIFS has elapsed. The STA may transmit the ACK frame at the recommended transmission rate included in the data frame. Alternatively, the STA may transmit the ACK frame at the rate higher or lower than the recommended transmission rate. Meanwhile, even though the STA does not receive the recommendation of the transmission rate, the STA may select the transmission rate (for example, 6 Mbps) of the ACK frame itself

As described above, according to the IEEE standard 802.11, the transmission rate of the response frame is the highest rate selected among the basic transmission rate set of the BSS while being equal to or less than the transmission rate of the request frame. However, under the environments such as error-prone channel, dense networks, long data frame transmission, and unsymmetric network conditions, the low transmission rate such as 6 Mbps is better than the high transmission rate. The reason is that since the ACK frame is very short, transmitting the ACK frame at 24 Mbps (16QAM) reduces only 16 μs compared to 6 Mbps (BPSK). On the other hand, the reason is that if the ACK frame is transmitted at 24 Mbps (16QAM), the transmission failure possibility is higher compared to 6 Mbps (BPSK), and therefore the long data frame needs to be re-transmitted more frequently.

According to another exemplary embodiment, the STA does not receive a recommendation of the response frame rate from the AP, but may select the ACK frame transmission rate itself. In particular, the STA may select the low transmission rate (for example, 6 Mbps). For example, if the AP transmits the data frame at 54 Mbps, the STA may transmit the ACK frame at 6 Mbps. In this case, neighbor devices receiving the data frame set the NAV timer at 24 Mbps according to the IEEE standard 802.11. Therefore, the ACK frame exceeds the NAV duration.

Further, another exemplary embodiment, when the STA receives the recommendation of the response frame rate from the AP, the recommended transmission rate may be used as the response frame rate or a rate lower or higher than the recommended transmission rate may be selected as the response frame rate.

However, even though the NAV duration elapses, neighbor devices do not immediately attempt the channel access but wait for the DIFS and the backoff. Therefore, even though the ACK frame is transmitted longer by 16 μs than the NAV duration, the collision due to the neighbor devices does not occur. As such, even though the transmission rate of the response frame is selected at a rate lower than the reference, the NAV duration may be protected without any problem.

Meanwhile, the STA waits for the DIFS after the ACK frame transmission is completed. However, when the STA itself selects the ACK frame transmission rate, the ACK frame transmission is delayed by 16 μs. Therefore, after the STA completes the ACK frame transmission at 6 Mbps and then waits for the DIFS, it is unfair to the STA in the channel access contention. To solve the unequal problem, the STA calculates the delay time occurring due to the low transmission rate and sets a timer to wait for a time (that is, DIFS-delay time) when the delay time is subtracted from the DIFS, instead of the DIFS.

The method for selecting a response frame transmission rate described with reference to FIGS. 1 to 20 is performed by an apparatus for selecting a response frame transmission rate. The apparatus for selecting a response frame transmission rate includes a memory storing instructions for performing the method for selecting a response frame transmission rate or loading the instructions from a storage and temporarily storing the loaded instructions, a processor executing the instructions stored in the memory or the loaded instructions to process the method for selecting a response frame transmission rate according to the exemplary embodiment, and a transceiver transmitting a frame generated by the processor or receiving the frame transmitted through the wireless communication network.

The apparatus for selecting a response frame transmission rate may be included in the WLAN device 1 of FIG. 1. In particular, the processor may be included in the baseband processor 10, the memory may be included in the memory 40, and the transceiver may be included in the RF transceiver 20 and the antenna unit 30 of FIG. 1.

The foregoing exemplary embodiments are not implemented only by an apparatus and a method, and therefore, may be realized by programs realizing functions corresponding to the configuration of the exemplary embodiment or recording media on which the programs are recorded.

Although various exemplary embodiments will be described above, these exemplary embodiments are not necessarily implemented alone and therefore two or more exemplary embodiments may also be coupled. Although the exemplary embodiment has been described in detail hereinabove, the scope is not limited thereto. That is, several modifications and alterations made by those skilled in the art using a basic concept as defined in the claims fall within the scope.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting frames by a device in a wireless local area network, the method comprising:
transmitting a first frame including a recommended transmission rate; and
receiving a second frame transmitted as a response of the first frame,
wherein the second frame is transmitted at a rate determined based on the recommended transmission rate.

2. The method of claim 1, wherein:
the recommended transmission rate is included in a transmission rate recommendation field, and
the transmission rate recommendation field is included in a PHY header or a MAC header of the first frame.

3. The method of claim 2, wherein:
the transmission rate recommendation field is included in a signal field of the first frame.

4. The method of claim 2, wherein:
the transmission rate recommendation field
includes a value indicating a designated transmission rate or modulation and coding scheme (MCS) index.

5. The method of claim 1, wherein:
a duration field of the first frame includes a duration value, and
the duration value is determined based on a transmission time of the second frame transmitted at the recommended transmission rate.

6. The method of claim 5, wherein:
a legacy signal (L-SIG) field of the first frame includes a data length, and
the data length is determined based on the first frame and the transmission time of the second frame transmitted at the recommended transmission rate.

7. The method of claim 1, further comprising:
determining the recommended transmission rate based on an interference condition.

8. The method of claim 7, wherein:
in the determining of the recommended transmission rate,
when an interference level is equal to or more than a first reference value, the recommended transmission rate is determined as a lower rate than a basic rate or when the interference level is equal to or less than a second reference value, the recommended transmission rate is determined as a higher rate than the basic rate,
the second reference value is a smaller than the first reference value, and
the basic rate is the highest rate among a basic transmission rate set of a basic service set (BSS) while being equal to or less than a transmission rate of the first frame.

9. A method for transmitting frames by a device in a wireless local area network, the method comprising:
receiving a first frame including a recommended transmission rate; and
transmitting a second frame at a transmission rate determined based on the recommended transmission rate.

10. The method of claim 9, wherein:
the recommended transmission rate is included in a transmission rate recommendation field of the first frame, and
the transmission rate recommendation field is included in a PHY header or a MAC header of the first frame.

11. The method of claim 10, wherein:
the transmission rate recommendation field is included in a signal field of the first frame.

12. The method of claim 9, wherein:
a transmission rate recommendation field
includes a value indicating a designated transmission rate or modulation and coding scheme (MCS) index.

13. The method of claim 9, wherein:
the transmission rate of the second frame is determined as a same rate as the recommended transmission rate.

14. The method of claim 9, wherein:
the transmission rate of the second frame is determined as a higher rate or lower rate than the recommended transmission rate.

15. A wireless local area network (WLAN) device, comprising:
a processor generating a first frame including a recommended transmission rate; and
a transceiver transmitting the first frame and receiving a second frame transmitted as a response of the first frame,
wherein the second frame is transmitted at a rate determined based on the recommended transmission rate.

16. The WLAN device of claim 15, wherein:
the processor
inserts the recommended transmission rate into a designated field of the first frame.

17. The WLAN device of claim 15, wherein:
the processor
calculates a transmission time of the second frame transmitted at the recommended transmission rate and sets a duration value of a duration field of the first frame based on the transmission time.

18. The WLAN device of claim 15, wherein:
the processor
calculates the first frame and a transmission time of the second frame transmitted at the recommended transmission rate and sets a data length of a legacy signal (L-SIG) field of the first frame based on the transmission time.

19. The WLAN device of claim 15, wherein:
the processor
determines the recommended transmission rate based on an interference condition.

20. The WLAN device of claim 19, wherein:
the processor
determines a lower rate than a basic rate as the recommended transmission rate when an interference level is equal to or more than a first reference value or determines a higher rate than the basic rate as the recommended transmission rate when the interference level is equal to or less than a second reference value,
the second reference value is smaller than the first reference value, and
the basic rate is the highest rate among a basic transmission rate set of a basic service set (BSS) while being equal to or less than a transmission rate of the first frame.
